(19) United States
(12) Patent Application Publication
(10) Pub. No.: US 2007/0082606 A1
(43) Pub. Date: Apr. 12, 2007

(54) Method for transmitting data relating to a service in a radio communication system and base station

(75) Inventors: Michael Eckert, Braunschweig (DE); Norbert Kroth, Potsdam (DE); David Randall, Hampshire (GB); Volker Sommer, Berlin (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, 80333 MUNICH (DE)

(21) Appl. No.: 10/579,390

(22) PCT Filed: Oct. 28, 2004
(86) PCT No.: PCT/EP04/52700

§ 371 Date: May 15, 2006

(30) Foreign Application Priority Data
Nov. 14, 2003 (EP) 03257200.0

(51) Int. Cl. H04H 7/00

(52) U.S. Cl. 455/3.06

(57) ABSTRACT

Messages relating to a multimedia broadcast/multicast service are transmitted in a radio communication system, where subscriber stations are informed by a service-dedicated paging display channel prior to the transmission of useful information as a service which is provided for several subscribers.

### CROSS REFERENCE TO RELATED APPLICATIONS

This application is based on and hereby claims priority to European Application No. 03257200 filed on Nov. 14, 2003, the contents of which are hereby incorporated by reference.

### BACKGROUND OF THE INVENTION

1. Field of the Invention

The invention relates to a method for the transmission of useful information in a radio communication system with at least one radio network control device, at least one base station and at least one subscriber station. The invention further relates to a base station radio communication system.

2. Description of the Related Art

Services are becoming increasingly important in wired and wireless communication systems. The anticipated development is predicted to lead to a distinct increase in the number of services available. This is very important in radio communication systems due to the mobility afforded to the subscriber.

In radio communication systems, information (for example voice, image, video, SMS [Short Message Service], MMS [Multimedia Message Service] or other data) is transmitted with the aid of electromagnetic waves via a radio interface between the transmitting and receiving stations (base station or subscriber station). The radiation of the electromagnetic waves takes place using carrier frequencies that lie within the frequency band provided for the particular system.

Frequencies of 900, 1800 and 1900 MHz are used for the introduced GSM (Global System for Mobile Communication) system. These systems mainly transmit voice, fax and SMS (Short Message Service) messages and also digital data.

For future mobile radio systems using the CDMA or TD/CDMA (Time Division/Code Division Multiple Access) transmission methods, such as UMTS (Universal Mobile Telecommunication System) or other third-generation systems, frequencies in the frequency band of approximately 2000 MHz are provided. These third-generation systems are developed with the aim of a worldwide radio coverage, a large range of services for data transmission and particularly a flexible administration of the capacity of the radio interface, which with radio communications systems is the interface with the fewest resources. With these radio communication systems it should be possible, above all by the use of flexible administration of the radio interface, for a subscriber station to transmit and/or receive, on demand, large amounts of data at a high data rate.

For the aforementioned UMTS mobile radio system, a distinction is made between an FDD (Frequency Division Duplex) mode and a TDD (Time Division Duplex) mode. The TDD mode is characterized particularly in that a common frequency band is used both in the UL (Uplink) and in the DL (Downlink) directions whereas the FDD mode uses a different frequency band for each transmission direction.

In cellular radio networks the connection between at least one base station and a subscriber station is by a radio communication interface. The base station can thus serve several radio cells, e.g. in the form of sectors.

Normally, the base station and a radio network control device (RNC Radio Network Controller) are part of a base station subsystem (RNS Radio Network Subsystem). A radio communication system normally has several base station subsystems, that are connected to a core network (CN Core Network). The radio network control device of the base station subsystem is connected to an access device (SGSN Serving GPRS Support Node) of the core network.

In addition to individual useful information, data that is available to several users is also transmitted in radio communication systems. For example, such useful information includes video streams or other broadcast and/or multicast information. The services for the transmission of useful information, that are not just provided individually for a single subscriber but are instead available to several subscribers, are summarized under the term MBMS (Multimedia Broadcast/Multicast Service). Different MBMS (Multimedia Broadcast/Multicast Service) services are provided by the core network, usually as separate data streams.

Before the useful information is made available to several subscribers as a service, the subscriber station of the subscribers requiring the service is informed prior to the actual transmission of the useful information of the service. This informing of the subscriber station is necessary so that the receivers can be configured. Depending on the mode in which a subscriber station is set (e.g. “connected mode” or “idle mode”), the information is provided, for example, in the form of a “notification” or “paging”. Normally, group-specific mechanisms are used to provide the information, with several subscriber stations being messaged at the same time.

The transmission of broadcast/multicast information should take place advantageously as services and in particular the unnecessary occupation of radio resources should be avoided where possible.

MBMS services are considered in more detail in the following, but this does not set any limitation on the teaching and application of the invention described here.

The support of the MBS (Multimedia Broadcast Multicast Service) is defined as part of the standardization of network functionalities of the UTRAN (UMTS Terrestrial Radio Access Network) and GERAN (GSM EDGE Radio Access Network) by 3GPP (3^{rd} Generation Partnership Project). Further details are given in technical specifications 3GPP TS 22.146 V6.2.0 (2003-03) and 3GPP TS 23.246 V1.1.0 (2003-07). The objective of the MBMS is to make multimedia data with a typically high data rate available simultaneously to a number of subscribers on jointly-used channels by unidirectional point-to-multipoint transmission, with advantageously only one MBMS radio channel being used per radio cell. The multiple transmission of the same data on several point-to-point connections or channels is advantageously avoided in this way.

To configure receiving subscriber stations in a radio cell appropriately for the reception of the MBMS, it is necessary to inform the subscriber stations before the actual data transmission of a service, by a notification or message. Furthermore, to support the discontinuous reception the use of the known UTRA paging mechanism for idle and URA/CELL_PCH subscriber stations is considered, with several subscriber stations being combined to form paging groups and messaged during a defined time period (DRX cycle) regarding specific events (e.g. paging a subscriber station to set up a voice connection).

The aforementioned discontinuous reception (DRX—Discontinuous Reception) of a subscriber station is known from chapter 8.3 of the technical specification 3GPP TS 25.304 V5.3.0 (2003-06) “User Equipment (UE) procedures in idle mode and procedures for cell reselection in connected mode (Release 5)”. In doing so the DRX cycle also marks a subscriber-station-individual time interval between paging timepoints (discontinuous reception cycle).

From chapter 8.1 of technical specification 3GPP TS 25 304 V5.3.0 (2003-06) and also particularly from chapter 5.3.3.10 of technical specification 3GPP TS 25.211 V5.4.0 (2003-06) “Physical channels and mapping of transport channels onto physical channels (FDD) (Release 5)” the PICH (Paging Indicator Channel) is also known. The PICH is a physical channel with a fixed data rate in which paging indicators can be transferred. The PICH is always associated with an S-CPPCH, on which a PCH Transport Channel is mapped.

FIG. 24 of chapter 5.3.3.10 of technical specification 3GPP TS 25.211 V5.4.0 (2003-06) shows the radio frame of 10 ms of the PICH. The frame uses 288 bits for paging indicators, with the remaining 12 bits of the frame not being currently used,.

In conjunction with the use of the UTRA paging mechanism, two implementation variants are presently discussed, as follows:
a) Use of existing subscriber-terminal-specific DRX cycles and use of the 12 bits as yet unused on the PICH.
b) Use of additional service-specific DRX cycles and use of the 288 bits already used on the PICH.

Implementation a) in this case has the advantage that the subscriber terminal has to receive only one PICH frame within its specific DRX cycle, which advantageously leads to a reduced energy consumption. The disadvantage however is the only small number (12) of bits that would be available to support a potentially large number of MBMS services.

Implementation b) on the other hand would have the advantage that a relatively large number (288) would be potentially available to identify MBMS services. Of course, this solution will have the disadvantage that the subscriber terminals would have to receive a larger number of PICH frames and the energy consumption would thus rise.

### SUMMARY OF THE INVENTION

An aspect of the invention is therefore to provide a method and a base station of the type named in the introduction that enables an efficient indication of services.

With the method in accordance with the invention for the transmission of data in radio communication systems in which subscriber stations are informed prior to the transmission of useful information as a service that is provided to several subscribers, informing the subscriber stations takes place using a service-dedicated paging indicator channel.

Messaging that informs several subscriber stations of a (point-to-multipoint) transmission of a service, for example an MBMS service, can thus take place independent of messages that are transmitted on a cell paging indicator channel, to inform individual subscriber stations of a subscriber-station-specific point-to-point connection, for example an incoming call. A subscriber-specific point-to-point connection is, for example set up to be circuit switched or packet switched. Messages for MBMS services sent simultaneously to subscriber stations can, in accordance with the invention, be sent independent of messages for subscriber-specific connections. The cell paging indicating channel, for example, corresponds to the PICH (Paging Indicator Channel) from chapter 8.1 of technical specification 3GPP TS25.304 V5.3.0 (2003-06) and also from chapter 5.3.3.10 of technical specification 3GPP TS 25.211 V5.4.0 (2003-06). The invention makes it possible for only subscriber stations provided for the reception of a service i.e. that have registered, for example, for the reception of an MBMS service, to receive the paging indicator channel dedicated for (point-to-multipoint transmitted) services, for example MBMS services. Especially, the service-dedicated paging indicator channel can transmit simultaneously with the cell paging indicator channel and be received by subscriber stations. The evaluation of the paging indicators received on the cell paging indicator channel and on the service-dedicated paging indicator channel can, for example, be sequentially carried out by the subscriber stations.

Advantageously, several discontinuous reception cycles of paging indicators are transmitted in the service-dedicated paging indicator channel.

A development of the invention provides that several discontinuous reception cycles of paging indicators are allocated service-specific or service-class-specific on the dedicated paging indicator channel. In this way, different types of services or different service classes can be allocated to different discontinuous reception cycles. A subscriber station then, for example, receives only those discontinuous reception cycles of services or service classes for the reception of which the subscriber station is intended or for the reception of which the subscriber station has been registered. In this way, the subscriber station receives only those reception cycles that it requests and thus reduces its energy consumption compared to the reception of all reception cycles. A subdivision of services into service classes can, for example, be transmitted by a subdivision into a service class of services, the data of which is transmitted in batches (e.g. video data [streaming video]) and into a service class with services, the data of which is continuously (download) transmitted.

In a further development, several discontinuous reception cycles of paging indicators with identical and/or different repletion rates are transmitted in the service-dedicated paging indicator channel. This enables the repetition rate for paging indicators to be independent, for example, of the service class for which a paging indicator is used. For example, a repetition rate that is greater the higher the service class of a service can be chosen.

It is advantageous if the paging indicators on the dedicated paging indicator channel includes information on a service control channel. Subscriber stations receive information through a paging indicator from which it can be concluded that information with respect to a service can be received on the service control channel. For example, the spread code with which the corresponding service is transmitted can be deduced from information received on the service control channel.

A development provides that at least one paging indicator on the dedicated paging indicator channel contains information for service identification for various services and/or various types of services. The subscriber station can thus evaluate the service identification information using the received paging indicator and determine whether it is a service or a service class that the subscriber station wishes to receive, or whether it is registered for this service or a service from the service class. Only if this is the case does the subscriber receive information subsequently transmitted on the service control channel.

In a preferred embodiment of the invention, a subscriber station, to acquire the message to the subscriber station using a service-dedicated paging indicator channel, receives either the paging indicators of the discontinuous reception cycle periodically on the indicator channel dedicated for the services or paging indicator information on a cell paging indicator channel.

It is appropriate that the paging indicator information on the cell paging indicator channel includes several bits for the indication of service information on the service-dedicated paging indicator channel. The use of several bits results in an information content of the paging indicator information of 2 to the power of the number of bits.

Using several bits advantageously enables the paging indicator information on the cell paging indicator channel to include an indication of the service class and/or a paging-specific sequence number. The subscriber station can thus detect which service class a succeeding paging indicator transmitted on the service-dedicated paging indicator channel refers to and/or which specific paging indicator, to which for example a paging-specific sequence number is allocated, is being subsequently transmitted. If the subscriber station, for example, has previously received a paging indicator on the service-dedicated paging indicator channel, to which the paging-specific sequence number is allocated, which the subscriber station takes from the currently received paging indicator information, the subscriber station does not again receive the paging indicator on the service-dedicated paging indicator channel. This avoids paging indicators already received being received again.

The base station in accordance with the invention and the associated radio communication system are particularly suitable for performing the method in accordance with the invention. Appropriate means and devices for performing the method and its embodiments and further developments can be present in the base station, the radio communication system or its individual components.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a radio communication network in accordance with the invention

FIG. 2 is a data flow diagram of a transmission in accordance with the invention by a service-dedicated paging indicator channel (MBMS PICH).

FIG. 3 is a data flow diagram of transmission in accordance with the invention using a service-dedicated paging indicator channel (MBMS PICH).

### DETAILED DESCRIPTION OF THE PREFERRED EMBODIMENT

Reference will now be made in detail to the preferred embodiments of the present invention, examples of which are illustrated in the accompanying drawings, wherein like reference characters refer to like elements throughout.

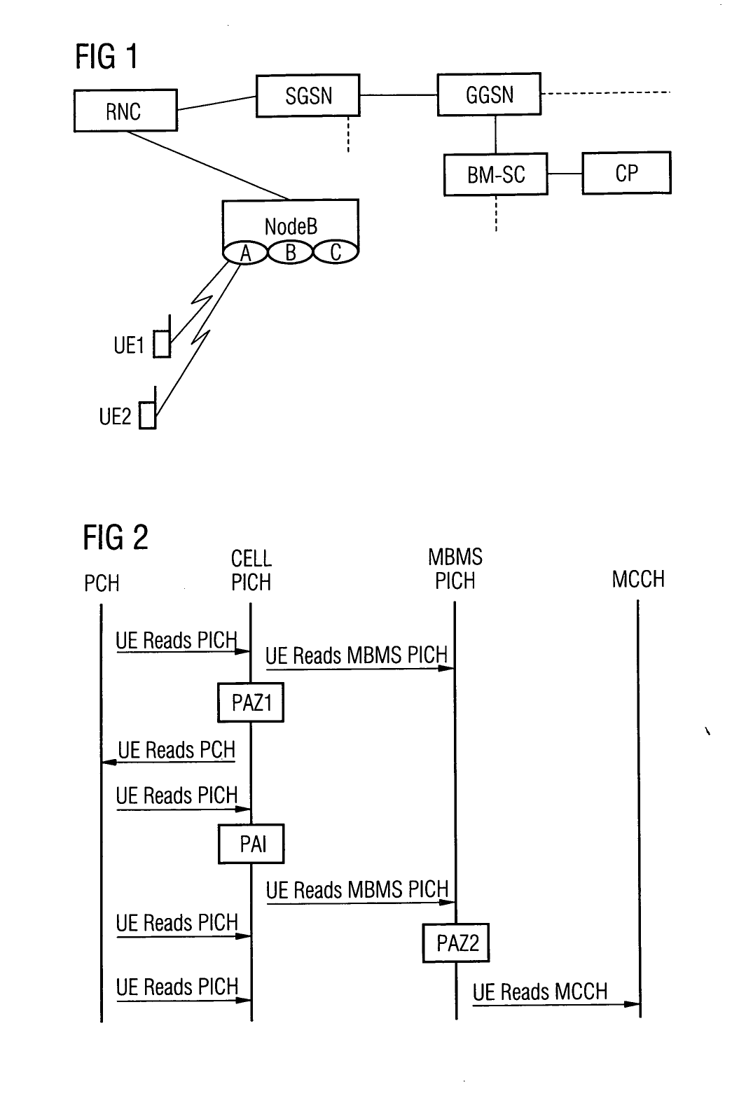

FIG. 1 shows a block diagram of the structure of a known radio communication system, as is, for example, realized in the described GSM or UMTS mobile radio system. The aforementioned technical specification 3GPP TS 23.246 V1.1.0 (2003-07) shows, in chapter 4.2, an example of an architecture reference model in which the invention can be used. The base station Node B serves radio cells A, B and C. The base station Node B is connected via a radio network control device RNC with an MSC (Mobile Switching Center) (not illustrated). The radio network control device RNC mainly performs.a central allocation of radio resources of several connected base stations Node B. The combination of base station Node B and radio network control device RNC is known as an RNS (Radio Network Subsystem). Each base station Node B can establish or release connections to subscriber terminals UE1 and UE2, for example mobile or stationery terminals, based on allocated radio resources.

The radio network control device RNC is furthermore connected via an SGSN (Serving GPRS Support Node) and a GGSN (Gateway GPRS Support Node) to a BM-SC (Broadcast-Multicast Service Center). The functionality of these devices is described mainly in chapters 5.1 and 5.4 of technical specification 3GPP TS 23.246 V1.1.0 (2003-07). The BM-SC in this case, for example, serves as an access interface for service providers CP (service or content providers) and for initiating the establishment of MBMS channels and the timing of data transmission on these channels. The SGSN on the other hand fulfills network control functions for the transmission of MBMS data. Further components of the system, not described in greater detail here, can also be used to realize the MBMS service.

In a similar manner, the invention can be used in the network components of a system of the second generation, e.g. GSM.

FIG. 2 is a schematic showing a flow diagram for a transmission in accordance with the invention using a service-dedicated paging indicator channel MBMS PICH.

A subscriber station UE, for example, subscriber terminal UE1 or UE2 receives a cell paging indicator channel CELL PICH corresponding to its discontinuous reception cycle. This is shown by the UE Reads PICH indicating arrows on the cell paging indicator channel CELL PICH. The subscriber station UE, during a first reception cycle, detects a first paging indicator PAZ1 according to the related art and, after processing the first paging indicator PAZ1, next receives a transport channel PCH. This is shown by a UE Reads PCH arrow.

During a further reception cycle on the cell paging indicator channel CELL PICH, the subscriber station UE receives paging indicator information PAI, that for example is formed by four bits. Alternatively, the paging indicator information PAI can also be formed from one bit or any other number of bits.

The received bit combination of the paging indicator information PAI is, for example, allocated to a service class that, in addition to other MBMS services, also includes an MBMS service provided for the subscriber station UE. To receive this MBMS service, the subscriber station UE has, for example, previously registered with a service provider. The subscriber station UE thus concludes from the paging indicator information PAI that a second paging indicator PAZ2 for the provided MBMS service is subsequently being transmitted on a service-dedicated paging indicator channel MBMS PICH.

As an alternative, or an addition, to an allocation of bit combinations of paging indicator information PAI to service classes, a specific service can also be allocated to at least one bit combination, for example the MBMS service provided for the subscriber station UE. A bit combination can, for example, correspond to a paging-specific sequence number to which a service is allocated. In this way, the paging indicator information PAI can explicitly indicate to the subscriber station UE whether a paging indicator of a specific service follows on the service-dedicated paging indicator channel MBMS PICH.

To transmit paging indicators of service classes that include the MBMS service provided for the subscriber station UE, a discontinuous reception cycle is used on the service-dedicated indicator channel MBMS PICH, which cycle in this example of an embodiment has a lower repetition rate than the discontinuous reception cycle of the first paging indicator PAZ1 of the subscriber station UE on the cell paging indicator channel CELL PICH. Of course, the repetition rate of the discontinuous reception cycle on the service-dedicated indicator channel MBMS PICH can also be greater or equal to the repetition rate for the cell paging indicator channel CELL PICH. The particular repetition rate according to FIG. 2 is inversely proportional to the distance (time difference) between adjacent arrows that point to the service-dedicated paging indicator channel MBMS PICH or to the cell paging indicator channel CELL PICH.

The second arrow pointing to the service-dedicated paging indicator channel MBMS PICH indicates the actual reception cycle, with the subscribe station UE meanwhile receiving the service-dedicated paging indicator channel MBMS PICH, triggered by the previously received paging indicator information PAI. During this reception cycle, the subscriber station UE receives the second paging indicator PAZ2. The second paging indicator PAZ2 shows the subscriber station UE that further information referring to the MBMS service is being subsequently transmitted on a service control channel MCCH. The subscriber station UE then receives the further information on the service control channel MCCH. The further information is required by the subscriber station UE in order to be able to subsequently receive the MBMS service. The reception on the service control channel MCCH is shown by the UE Reads MCCH arrow.

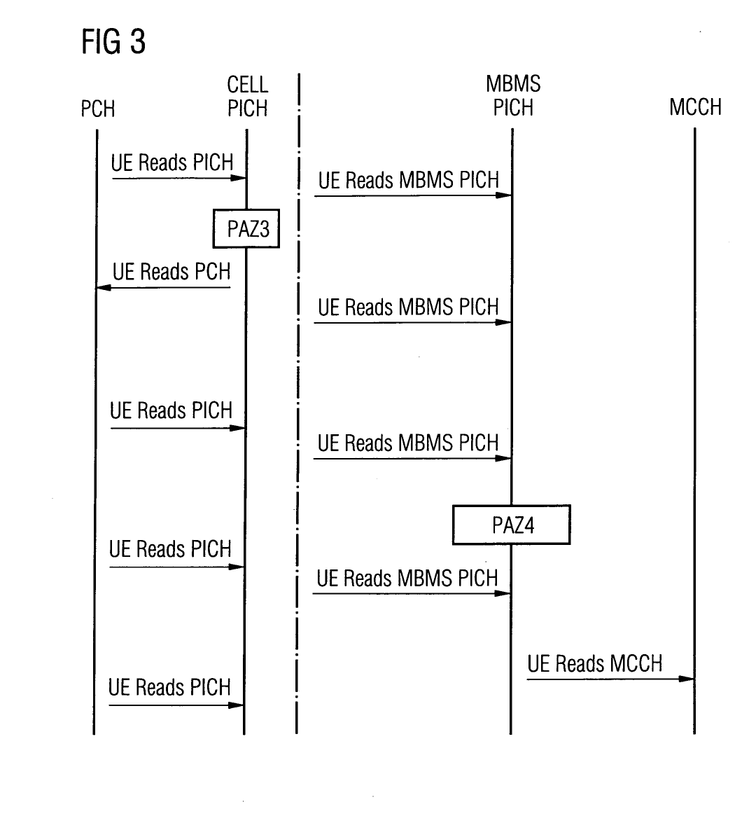

An alternative embodiment of the invention is schematically illustrated in FIG. 3. The subscriber station UE reads the cell paging indicator channel CELL PICH corresponding to its discontinuous reception cycle and receives a third paging indicator PAZ3. Following this the subscriber station UE, as already described using FIG. 2, receives the transport channel PCH given in the third paging indicator PAZ3.

In this exemplary embodiment, no paging indicator information PAI is transmitted on the cell paging indicator channel CELL PICH. Instead a discontinuous reception cycle is periodically transmitted on the service-dedicated paging indicator channel MBMS PICH. This discontinuous reception cycle has, as can be seen by the distance of the corresponding UE Reads MBMS PICH arrows in FIG. 3, a higher repetition rate than the discontinuous reception cycle on the service-dedicated paging indicator channel MBMS PICH, shown in FIG. 2. For example, the discontinuous reception cycle in FIG. 2 is used for a different service class or a different service than the discontinuous reception cycle in FIG. 3. Of course, the discontinuous reception cycle shown in FIG. 2 can also be used with the same repetition rate, in addition to the discontinuous reception cycle shown in FIG. 3, on the service-dedicated paging indicator channel MBMS PICH. The subscriber station UE in this exemplary embodiment (not illustrated) receives one of the discontinuous reception cycles or both reception cycles, with the reception cycles in each case being assigned to at least one service class or one service.

After the subscriber station UE in FIG. 3 has received during two reception cycles, shown by the first two arrows UE Reads MBMS PICH, on the service-dedicated paging indicator channel MBMS PICH without receiving a paging indicator, it receives a fourth paging indicator PAZ4 during a third reception cycle. The fourth paging indicator includes information for service identification by which the subscriber station detects that the fourth paging indicator PAZ4 refers to an MBMS service that is intended to be received by the subscriber station UE. Furthermore, the fourth paging indicator PAZ4 indicates to the subscriber station UE that further information necessary to be able to receive the provided MBMS service can be received on the service control channel MCCH. The subscriber station UE therefore subsequently receives the further information, shown by the UE Reads MCCH arrow, on the service control channel MCCH.

If the subscriber station UE receives, on the service-dedicated paging indicator channel MBMS PICH, a paging indicator with information by which a service is identified for whose reception the subscriber station UE is not intended, no further information is received on the service control channel.

Of course, in accordance with the invention, both subscriber terminal UE1 and subscriber terminal UE2 can, at the same time, receive both the same and different discontinuous reception cycles of paging indicators, and thus the same or different paging indicators, on the service-dedicated paging indicator channel. The reception, of course, takes place as described in the above example for subscriber station UE using the exemplary embodiments shown in FIGS. 2 and 3. Different subscriber stations, for example different subscriber terminals, can in accordance with the invention receive paging indicators both for the same service classes or services and for different service classes or services at the same time.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for transmission of data in a radio communication system having subscriber stations, comprising:
informing the subscriber stations of a service which is provided for several subscribers, prior to the transmission of useful information, by providing, via a multimedia broadcast/multicast service-dedicated paging indicator channel, a paging indicator for service control information on a service control channel.

16. A method in accordance with claim 15, wherein said informing comprises transmitting several discontinuous reception cycles of paging indicators in the multimedia broadcast/multicast service dedicated paging indicator channel.

17. A method in accordance with claim 16, wherein the several discontinuous reception cycles of paging indicators with at least one of identical and different repetition rates are transmitted in the multimedia broadcast/multicast service dedicated paging indicator channel.

18. A method in accordance with claim 17, wherein the several discontinuous reception cycles of paging indicators are allocated service-specific or service-class specific on the multimedia broadcast/multicast service dedicated paging indicator channel.

19. A method in accordance with claim 18, wherein at least one paging indicator on the multimedia broadcast/multicast service dedicated paging indicator channel contains service identification information for at least one of various services and various types of service.

20. A method in accordance with claim 19, wherein said informing further comprises receiving paging indicator information on a cell paging indicator channel at the subscriber station to acquire the paging indicator using the multimedia broadcast/multicast service dedicated paging indicator channel.

21. A method in accordance with claim 20, wherein the paging indicator information on the cell paging indicator channel contains several bits for indicating service information on the multimedia broadcast/multicast service dedicated paging indicator channel.

22. A method in accordance with claim 21, wherein the paging indicator information on the cell paging indicator channel includes an indication of at least one of a service class and a paging-specific sequence number.

23. A method in accordance with claim 19, wherein said informing further comprises periodically receiving paging indicators of discontinuous cycles on the multimedia broadcast/multicast service dedicated paging indicator channel.

24. A base station for transmission of data in a radio communication system, comprising:
means for informing subscriber stations prior to transmission of useful information as a service that is provided for several subscribers, and
means for creating and transmitting, to subscriber stations, paging indicators for service control information on a service control channel, using a multimedia broadcast/multicast service dedicated paging indicator channel.

25. A base station in accordance with claim 24, further comprising means for transmitting several discontinuous reception cycles of the paging indicators on the multimedia broadcast/multicast service dedicated paging indicator channel.

26. A base station in accordance with claim 25, wherein said means for transmitting several discontinuous reception cycles of the paging indicators on the multimedia broadcast/multicast service dedicated paging indicator channel uses at least one of identical and different repetition rates.

27. A base station in accordance with claim 26, further comprising means for allocating several discontinuous reception cycles of paging indicators on the multimedia broadcast/multicast service dedicated paging indicator channel to at least one of specific services and specific service classes.

28. A subscriber station for performing a method for transmission of data, comprising:
means for receiving paging indicators at said subscriber station using a multimedia broadcast/multicast service dedicated paging indicator channel, with either paging indicators of discontinuous reception cycles on the multimedia broadcast/multicast service dedicated paging indicator channel being periodically received or paging indicator information being received on a cell paging indicator channel to acquire a paging indicator on the multimedia broadcast/multicast service dedicated paging indicator channel, and with the paging indicators provided for service control information on a service control channel.

29. A radio communication system for transmission of data, comprising:
at least one base station including
means for informing subscriber stations prior to transmission of useful information as a service that is provided for several subscribers, and
means for creating and transmitting, to subscriber stations, paging indicators for service control information on a service control channel, using a multimedia broadcast/multicast service dedicated paging indicator channel; and
at least one subscriber station including means for receiving paging indicators at said subscriber station using the multimedia broadcast/multicast service dedicated paging indicator channel, with either paging indicators of discontinuous reception cycles on the multimedia broadcast/multicast service dedicated paging indicator channel being periodically received or paging indicator information being received on a cell paging indicator channel to acquire a paging indicator on the multimedia broadcast/multicast service dedicated paging indicator channel.
